(19) United States
(12) Patent Application Publication
(10) Pub. No.: US 2018/0326628 A1
(43) Pub. Date: Nov. 15, 2018

(54) Method For Manufacturing A Home Appliance Component In A Combined Injection-Molding Process Involving Thin-Wall Injection-Molding And Cascade Molding And Home Appliance Component

(71) Applicant: BSH HAUSGERAETE GMBH, MUENCHEN (DE)

(72) Inventors: BRIGITTE FURTH, KITZINGEN (DE); SVEN HOLT, ULM (DE); ALFRED RAAB, HUETTLINGEN (DE); TOBIAS HEISSWOLF, SYRGENSTEIN (DE)

(21) Appl. No.: 15/775,846

(22) PCT Filed: Oct. 31, 2016
(86) PCT No.: PCT/EP2016/076219

§ 371 Date: May 14, 2018

(30) Foreign Application Priority Data
Nov. 27, 2015 (DE) 10 2015 223 585.8

(51) Int. Cl. B29C 45/00; F25D 23/06

(52) U.S. Cl. CPC B29C 45/0025; B29C 45/0046; B29L 2031/7622; B29C 2045/0032; B29C 2045/0094; F25D 23/064

(57) ABSTRACT

A method for manufacturing a component for a home appliance includes making the home appliance component from plastic in an injection molding process. During at least some phases of the injection molding process a combination of the thin-wall injection molding technique and the cascade molding technique is used. The invention also relates to a home appliance component manufactured according to the method.

The invention relates to a method for manufacturing a home appliance component for a home appliance, wherein the home appliance component is made from plastic. The invention also relates to a home appliance component.

Plastics components as home appliance components for a home appliance are generally known. Such home appliance components, for example as door racks on an inner face of a door, are specifically known for home refrigeration appliances in the form of a refrigerator or a freezer or a combi fridge-freezer. Moreover, large components such as internal cladding and/or an internal door of the main door which is pivotably arranged on a housing for closing a receiving space for food, are also known. These home appliances are relatively large and are manufactured in a current implementation of the forming process, in particular by thermoforming. To this end, previously extruded semi-finished products in the form of plates or coils are used.

Flat home appliance components may also be manufactured by means of conventional injection-molding. The wall thickness of these components, however, is downwardly limited, since in order to fill up the injection mold completely, a minimum wall thickness is required. In particular, in the case of larger components, the wall thicknesses are substantially more than 1.5 mm. In these methods, the melt is introduced via a single injection point into the injection mold. In particular, in the case of such large home appliance components which are to be manufactured and which are also configured to be flat and/or planar over large areas, in conventional manufacturing processes the wall thickness is downwardly limited. This is also due to the fact that the closing forces for the injection mold are very large. Due to this relatively large wall thickness the cooling of the melt takes a very long time.

Therefore, in current manufacturing technology, particularly with large components, thermoforming is preferred to injection-molding, also for economic reasons.

It is the object of the present invention to provide a method, home appliance components being able to be manufactured thereby in an improved manner by injection-molding. In particular, it is also the object of the invention to provide a corresponding home appliance component.

This object is achieved by a method and a home appliance component as claimed in the independent claims.

In a method according to the invention for manufacturing a home appliance component for a home appliance, this home appliance component is manufactured entirely from plastics. An essential idea of the invention may be seen to be that the home appliance component is manufactured by injection-molding, wherein during this injection-molding a combination of specific individual injection-molding techniques are carried out during at least some phases and thus at least occasionally during the manufacturing process, and thus said techniques are also combined. According to the invention, therefore, in the injection-molding process, a combination of thin-wall injection-molding and cascade molding is used during at least some phases thereof. By such a method, therefore, the home appliance component is configured to be thin-walled and, by the plurality of injection points required in cascade molding, the introduction of the melt is possible. By this specific combination, in a particularly novel and advantageous manner it is also achieved that locking forces of the injection mold may be kept relatively low during the manufacture of the home appliance component. In particular, therefore, at some points the injected melt is already solidified and at other points the melt is not yet injected or has only just been injected. This means that injection molds which were able to be used in the case of the hitherto conventional technique, which was limited, are now also able to be used. The reduction of the wall thickness of the home appliance component, on the one hand, results in a reduction of the required locking forces. When only one injection point is used in such a thin-walled embodiment, however, there are drawbacks when injecting the melt and with relatively large components with regard to the undesirable premature solidifying at the one point and the insufficient supply of the melt to all points, a relatively large injection pressure might be required in this case, which in turn would lead to increased locking forces for the injection mold. Moreover, in such an embodiment, therefore, a drawback might be seen to be that during the cooling and thus in the case of a certain level of shrinkage of the plastics, a secondary injection might be necessary for refilling, and/or at high pressure, which once again leads to high locking forces.

By means of the invention, this problem is solved by the cascade molding and thus a plurality of injection points, on condition that thin-wall injection-molding is carried out. By the plurality of injection points, it is possible to prevent solidifying at specific points of the melt which is too premature but very rapid and therefore the melt may be introduced relatively uniformly so that the solidifying, on the one hand, and the supply of the melt to all points in the injection mold, is carried out for the complete and final shaping of the home appliance component to be produced. By the plurality of injection points, therefore, the reduction of the required locking forces of the injection mold, which is already associated with the thin-walled manufacture, is also further promoted. This novel method in the form of combining two quite specific injection-molding methods, therefore, also enables injection molds and machines to be used which are advantageous relative to the economical manufacture of the home appliance component and, in this connection, where lower locking forces are sufficient. Since these machines and injection molds, with regard to their respective maximum locking force, are a significant cost factor in production plants, in this connection a particular advantage may be achieved by the invention. Therefore, in particular, relative to the already aforementioned injection-molding production of such larger home appliance components, which however may only be manufactured as thick-walled components, no other injection molds which are different and which are able to be subjected to greater locking forces have to be used, and in contrast even these conventional appliances and machines may be used. By means of the invention, therefore, the primary injection of melt may be carried out at injection points and at the same time a secondary injection of melt may be carried out at injection points, via which the primary melt previously injected in the injection mold is already cooled.

In this connection, the invention is particularly advantageous for relatively large home appliance components which have large amounts of planar or substantially planar flat areas. Since in the case of such specific shapes of home appliance components, as is the case for example of internal cladding and/or internal doors of a door of a home refrigeration appliance, conventional injection-molding as has been described above in the introduction is not economical, this is remedied by the invention.

Preferably, the thin-wall injection-molding is carried out during the injection-molding process with a characteristic parameter relative to the wall thickness-flow path ratio of more than 1:200. Particularly advantageously, this thin-wall injection-molding is carried out at a wall thickness-flow path ratio of between more than 1:200 and more than 1:300. By such a value and/or a value interval of the characterizing parameter, the aforementioned advantages may be achieved, in particular. Specifically in the case of larger components to be manufactured, with large flat areas, therefore, a preferred thinness of the walls with at the same time sufficient solidifying of the melt and yet sufficient speed of the flow fronts may also be achieved. As a result, the home appliance component is produced accurately in terms of shape and to be thin-walled, wherein the locking forces may be kept relatively small, in particular even in the cooling phase which is then shorter due to the thin walls.

It is preferably provided that, viewed in the direction of the longitudinal axis of the home appliance component, for the cascade molding at least one injection point is centrally predetermined from the plurality of injection points. Via this at least one central injection point, an injection of a melt of the plastics material into an injection mold is initiated at least partially before the injection of the melt in at least one further injection point which is predetermined eccentrically, when viewed along the longitudinal axis of the home appliance component. This is also a very advantageous method, on the one hand, with regard to the position of the injection points and, on the other hand, with regard to the sequence as to when the melt is injected and at which specific injection points. When the thinness of the walls is produced, the aforementioned advantages are even further improved by these specific methods.

It may be provided that a central positioning is provided for the at least one central injection point, even in the width direction which is oriented perpendicular to the longitudinal axis of the home appliance component. As a result, a symmetrical position is also predetermined by this one central injection point, said position also permitting a symmetrical distribution of the melt in the direction of the longitudinal axis and in the direction of the width of the home appliance component.

It is provided, in particular, that the at least one central injection point and the at least one eccentrically predetermined injection point are located on a common line which corresponds to the longitudinal axis or extends parallel to this longitudinal axis.

Preferably, a time for the start of an injection in an eccentrically predetermined injection point is predetermined according to the type of melt to be injected and/or according to the type of melt injected in the at least one central injection point and/or a spacing measured along the longitudinal axis between the at least one central injection point and the eccentric injection point and/or the diameter of the at least one central injection point and/or the diameter of the eccentric injection point and/or the number of eccentric injection points at the same longitudinal position along the longitudinal axis relative to this eccentric injection point and/or the injection pressure of the melt in the at least one first central injection point and/or the injection pressure provided in the eccentric injection point and/or the quantity of the melt injected into the at least one central injection point and/or the quantity of the melt provided to be injected in the eccentric injection-molding point and/or a time period of an injection of a melt via the central injection point.

Additionally or alternatively, it may also be provided that a time for the end of an injection in an eccentrically predetermined injection point is predetermined according to the type of melt to be injected and/or according to the type of melt injected in the at least one central injection point and/or a spacing measured along the longitudinal axis between the at least one central injection point and the eccentric injection point and/or the diameter of the at least one central injection point and/or the diameter of the eccentric injection point and/or on the number of eccentric injection points at the same longitudinal position along the longitudinal axis relative to this eccentric injection point and/or the injection pressure of the melt in the at least one first central injection point and/or the injection pressure provided in the eccentric injection point and/or the quantity of the melt injected into the at least one central injection point and/or the quantity of the melt provided to be injected in the eccentric injection point and/or a time period of an injection of a melt via the central injection point.

As a result, the cascade molding is carried out very accurately relative to the melt to be injected and the injection points, so that the speed of the flow fronts of the melt and the desired cooling takes place at specific points in a very coordinated manner and, as a result, also in the case of very different home appliance components, in particular with large planar or substantially planar surface areas in comparison with the overall size of the home appliance component, rapid production which is accurate in terms of shape is possible with relatively small locking forces of the injection mold.

This flexibility with regard to taking into account very different parameters which may be considered relative to the time for the start of the injection on an eccentrically predetermined injection point and/or relative to the time for the end of an injection of the melt in this eccentrically predetermined injection point, results in very individual scenarios for adapting the manufacture of a home appliance component. Thus an exceptionally finely adjusted and thus accurate adjustment may be carried out with regard to the shape and, in particular, the size of the home appliance component, at least from one of these times. As a result, the accuracy of manufacturing the home appliance component with regard to the uniform wall thickness is advantageously accommodated. In this case, with regard to the requirements for permitting locking forces which are as low as possible in the injection mold and thus in particular for using conventional locking forces and corresponding injection molds, therefore, an individually adapted injection process may be controlled. Undesirably high locking forces or locking force peaks may be avoided thereby.

By this aforementioned advantageous embodiment, by the fine adjustment of the injection process and thus the corresponding control via a control unit of the production plant, the number of potential rejects of home appliance components may also be significantly reduced.

In particular, at least one first eccentric injection point is predetermined in at least the one central injection point in a first direction along the longitudinal axis and, starting from the at least one central injection point, at least one second eccentric injection point is predetermined in a second direction opposing the first direction along the longitudinal axis of the home appliance component. With the injection of the melt in the at least one central injection point, the injection of a melt is carried out in the at least one first and the at least one second eccentric injection point, at least partially, in particular entirely, simultaneously. As a result, the filling process of the injection mold with the melt is carried out in two directions which extend opposing the longitudinal axis and, in particular, is carried out synchronously. The progress of the production, therefore, takes place in two opposing directions at the same time, so that, viewed in the direction of the longitudinal axis, at the same time the melt material is also moved toward the respective opposing ends of the home appliance component to be manufactured, so that the introduction process and the respective successive subsequent solidifying also takes place synchronously at points opposing the center, viewed in the direction of the longitudinal axis. As a result, the aforementioned advantages are further promoted since the flow fronts extend in two opposing directions and due to the subsequent introduction carried out in this direction at these points and the respective subsequent solidifying, the locking forces of the injection mold may also be kept as low as possible.

In one advantageous embodiment, for the cascade molding, viewed in the direction of the longitudinal axis of the home appliance component, at least two injection points on the same longitudinal position and on opposing sides of the longitudinal axis and thus perpendicular to the longitudinal axis are predetermined from the plurality of injection points, wherein via these at least two injection points located equally along the longitudinal axis, a melt of the plastics material is injected simultaneously into an injection mold. As a result, regarding the width of the home appliance component measured perpendicular to the longitudinal axis, an improvement in the manufacture is achieved and the already aforementioned advantages are also provided here.

Specifically in the case of wider home appliance components, in particular relative to wider surface areas, by this plurality of injection points in the width direction, the introduction of the melt material, the solidifying of the melt material and the required secondary injection take place in an improved manner and, relative thereto, with locking forces of the injection mold which are as low as possible and minimized.

Preferably, it is provided that by the combination of the thin-wall injection-molding and the cascade molding, which is carried out simultaneously, the home appliance component is manufactured with a wall thickness of less than 1.5 mm and particularly advantageously between 0.6 mm and 1 mm. In conventional injection-molding means, however, minimum wall thicknesses of 2.5 mm may be produced. By the invention and/or advantageous embodiments thereof, even with very large home appliance components with, in particular, relatively large planar surface areas or substantially planar surface areas, a considerable reduction in wall thickness may be achieved and thus only a thin-walled area is configured, wherein the thinness of the walls in this case is very small. This has a particularly advantageous effect, in such specific home appliance components having a plurality of injection points for cascade molding, on the required locking forces of the injection mold, not only during the primary injection of the melt but also during the solidifying and/or cooling and in particular optionally a subsequent secondary injection due to shrinkage of the solidified melt.

Not only by this advantageous embodiment but also due to the thinness of the walls, the cooling may take place more rapidly, whereby a required secondary injection may also carried out soon afterward, but due to this reduced cooling time the locking process of the injection mold may be reduced in terms of time, which in turn provides advantages for the requirements for the injection mold with regard to the energy consumption of the production process, so that the production process may also take place in a more energy efficient manner.

Preferably, it is provided that at least four injection points are predetermined for the cascade molding. According to the design of the home appliance component to be manufactured, and in particular the size thereof, preferably the size of the planar or substantially planar surface area thereof, the number of injection points may also be predetermined to be greater than 10, in particular greater than 30, in particular greater than 50, in particular greater than 70, in particular greater than 90 and optionally even up to 100 injection points or more.

In a particularly advantageous embodiment, a trough-shaped home appliance component is manufactured as the home appliance component. In particular, in this connection an internal cladding and/or an internal door of a door of a home appliance, which is configured for closing a receiving space for food, is manufactured. Therefore, with regard to the production sequence, an improved method may be provided for these specific home appliance components. Relative to the improvements, reference should be made once again to the advantages already mentioned above.

In an advantageous manner, a trough base of the trough-shaped home appliance component is manufactured with a quadrangular surface area having a first side length, in particular a width, of at least 30 cm and/or a second side length, in particular a height, of at least 25 cm. Such home appliances with relatively large surface areas, therefore, may be achieved by the method according to the invention or an advantageous embodiment thereof relative to the reduction of the time taken for the manufacturing process, in particular the cooling time of the melt, relative to the requirements for locking forces of the injection mold and also relative to the sharpness of the contours and the full introduction of the melt, even in edge regions with relatively lower injection pressures of the melt.

Preferably, injection points for the cascade molding are predetermined according to the size of the trough-shaped home appliance component to be manufactured.

In particular, injection points of this cascade molding may be predetermined according to the size of the planar or substantially planar surface area of a trough base of the home appliance component. Since these specific geometric areas of such a home appliance component are significant relative to the injection points, the injection pressures, the distribution of the melt with regard to the solidifying which is optionally too rapid or too slow and thus undesirable, and the optionally required rise in locking forces of the injection mold, it is possible to react thereto in a manner which is very situation-dependent and it is possible to remedy this here by the advantageous embodiment, on the one hand, by the thinness of the walls and, on the other hand, by the specific local injection points.

In a further advantageous embodiment, it is provided that the number of injection points along a longitudinal axis of the home appliance component and/or the position of the injection points are predetermined according to the size of the trough-shaped home appliance component to be manufactured. In this case this predetermining, in particular, takes place according to the size of the planar or at least substantially planar surface area of a trough base of the home appliance component. The advantages already set forth above for the other embodiments accordingly apply here.

In a further advantageous embodiment, it is provided that the number of injection points is predetermined in pairs and on opposing sides of a longitudinal axis and thus in the width direction relative to the longitudinal axis of the trough-shaped home appliance component and the number of these injection point pairs is predetermined according to the size of the trough-shaped home appliance component to be manufactured. Also in this embodiment, this number of injection point pairs is predetermined according to the size of the planar or substantially planar surface area of a trough base of the home appliance component. In this case, the advantages already set forth above also apply accordingly.

In an advantageous embodiment, a locking force for locking an injection mold when injection-molding the home appliance component with the combined, and thus the simultaneous, implementation of thin-wall injection-molding and cascade molding is correspondingly limited to a value of less than or equal to a weight of 1700 tons. In particular, this locking force is correspondingly limited to a value of less than or equal to a weight of 1600 tons. This is a very advantageous embodiment, therefore, since injection molds may be used in which these specified locking forces may also be provided in practice, in particular, as maximum locking forces. As a result, injection molds which are substantially smaller and also more cost-effective to produce and also during operation, in comparison with injection molds which permit significantly higher locking forces, may be used for the manufacturing process. Since in this case these specified costs for injection molds with locking forces are not only linear but also increase to a significantly greater degree, such drawbacks also form a significant part of the production costs and thus of the means for implementing a production method using such injection molds. By means of the invention or an advantageous embodiment thereof, it is now also possible to use significantly more cost-effective injection molds with lower maximum locking forces and still manufacture the aforementioned and, in particular, very large home appliance components characterized by large planar or substantially planar surface areas. This was not possible with the previous injection-molding technology. The combination of the thin-wall injection-molding technology with cascade molding permits locking forces to be reduced, in the case of these specific, in particular trough-shaped, home appliance components cited relative thereto, such that conventional injection-molding machines and even injection-molding machines with lower locking forces may also be used.

By means of this invention it is also possible that these low locking forces, in particular less than or equal to a value corresponding to a weight of 1700 tons, are not only sufficient for the primary injection process of the melt but also for locking during the cooling process and also the possibly required secondary injection of melt due to shrinkage during cooling.

In particular, as already mentioned above, an internal cladding and/or an internal door of a door for a home refrigeration appliance is manufactured as a home appliance component. Due to their trough shape these components generally have a relatively large planar or substantially planar surface area in the form of the trough base, so that here the aforementioned problems are particularly significant, but by the solution according to the invention an advantageous manufacture is now possible of these specific home appliance components and namely within the context of the injection-molding.

The invention further relates to a home appliance component which is manufactured according to the invention or an advantageous embodiment thereof. By the method according to the invention a markedly reduced wall thickness, namely a thin wall, is also now possible in these specific home appliance components and yet a sufficiently complete filling of the melt and a sufficient secondary compressive action with rapid manufacture are possible. For home appliance components to be manufactured, in which the maximum flow paths of the melt to be introduced are greater than 200 mm, the wall thickness of significantly less than 1.5 mm is also now possible. If, for example, a very free flowing plastics is used as the melt, viewed along the longitudinal axis of the home appliance component and/or perpendicular to the longitudinal axis, and thus in the width direction of the home refrigeration appliance, the spacing of injection points may be larger. As a result, the required number of injection points relative to a fixed component size is reduced.

By the simultaneous and/or also combined cascade molding, the filling of the injection mold with the melt is not carried out simultaneously in this thin-wall technology via all injection points but one after one another and thus cascaded. The individual cascade steps are in this case denoted as sequence zones.

For introducing the melt into the injection mold and thus for the filling process, as already mentioned above, very many different types of activation and deactivation for the individual sequence zones, which is very situation-dependent, may be undertaken specifically for the home appliance component to be manufactured in each case. The control of the sequence zones may, for example, also be implemented via the injection volume, the injection path, the injection time, the injection pressure or the position of the flow front of the melt in the cavity and/or the injection mold.

In an advantageous embodiment, the determination of the position of the flow front in the injection mold is carried out, for example, by the measurement of the local mold internal pressure or the local mold wall temperature.

To this end, a sensor or corresponding sensors may be provided on the surface of the injection mold. If, for example, a predetermined temperature threshold value is exceeded, it is possible to deduce the exact position of the flow front inside the injection mold. By means of the invention, the achievable pure wall thicknesses and thus the thin-walled embodiment are irrespective of the size of the home appliance component to be produced. Moreover, it may also be provided that surfaces of the home appliance component to be manufactured may be entirely structured or at least partially structured individually, wherein in this case for example different degrees of shine or matt surfaces may be produced. A sensor may also be integrated in the wall of the injection mold and thus completely enclosed by the material of the wall.

It is preferably provided that the position of a flow front is determined according to one or more injection times at one or more injection points.

It is preferred if the home appliance component is at least partially manufactured from PP (polypropylene), in particular entirely from PP. This material makes it possible, with the thinness of the walls and the plurality of injection points, with its flow properties—PP is free-flowing—specifically to fulfil the aforementioned advantages, in particular when large home appliance components are produced with large planar and/or substantially planar surface areas.

In a further very advantageous embodiment, it may also be provided that the home appliance component is not only manufactured from a single plastics material but is produced from at least two different plastics materials. Such a two-component home appliance component may be produced very accurately relative to the different injection points, from the respective different plastics materials locally required.

By the method according to the invention or an advantageous embodiment thereof, many different types of home appliance components may be produced, not only in terms of shape but also size. For example, small thin-walled home appliance components may be produced with relatively large and planar or substantially planar surface areas. Thus these home appliance components may be manufactured with a height of up to 30 cm, a width of up to 15 cm and a wall thickness of less than 1 mm, in particular between 0.5 mm and 0.9 mm, in particular 0.8 mm. However, home appliance components which are even larger relative thereto may also be manufactured, said components being able to be configured with a height of 180 cm or larger, with a width of between 60 cm and 90 cm, in particular 80 cm, and in particular a wall thickness of less than 1 mm, preferably between 0.5 mm and 0.9 mm, in particular 0.8 mm. However, any intermediate values of the cited heights and/or widths and/or wall thicknesses are possible as further embodiments individually or in combination.

By means of the invention, as already mentioned above, it is possible to achieve a significant reduction in the closing forces and/or locking forces of the injection-molding machine and/or the injection mold otherwise required for such components. With the usual conventional injection-molding techniques, the filling pressure and/or the secondary pressure acts at the same time on the entire projected surface of the component to be manufactured. For the manufacture of larger components, using conventional injection-molding, therefore, injection-molding machines are required with very large closing forces. By the method according to the invention, the required closing force with the same component size may be reduced by up to 80 percent, in particular in the case of trough-like home appliance components which, in comparison with the remaining area of the home appliance component, have a very large planar or substantially planar surface area.

Moreover, due to the associated small wall thickness which is produced, and thus the thinness of the walls, the component regions which have been filled up first already solidify during the filling process. This is a significant advantage. When the injection mold is completely filled up with the melt, already larger regions of the home appliance component to be manufactured are solidified. The internal pressures, however, act only in the regions in which the melt is still present and thus the liquid plastics material is still present. Thus the internal pressure only acts on a partial region of the entire projected component surface. In order to prevent the collapse of the component or individual component regions by the thermal contraction of the plastics during cooling, in conventional injection-molding, after the filling is completed, the component to be manufactured is subjected to secondary pressure.

In the invention with the combined thin-wall injection-molding and the cascade molding, after the filling is completed this secondary pressure is ineffective for the component regions which are already solidified. The secondary pressure for these component regions is already ensured by the filling pressure during the filling of the component, which is a further substantial advantage of the invention. The filling pressure in this case during filling acts firstly partially to the front and thus in the direction of the widening flow front and as secondary pressure partially to the rear. The significant reduction of the closing forces is only provided by the combination of the thin-wall technology and cascade molding for flat component shapes of the home appliance components to be manufactured.

By the thin wall production, the cooling times are drastically reduced and by the flat component shapes, in combination with the chronologically staggered injection points, a simultaneous filling action and secondary pressure action is possible. Thus during the manufacturing method and thus at the times when the entire plastics material has not yet been introduced, the primary introduction of melt may take place at certain locations via certain injection points and at the same time, at different locations in which the previously introduced melt is already cooled, a secondary pressure may be implemented.

Moreover, by means of the invention it is also possible that the basic construction of the injection mold may be used for a family of home appliance components which in this context are of the same shape and therefore differ only in size. Thus with corresponding home appliance components of different dimensions, the number of injection points of the injection mold used may be freely selected. Thus, for example, it is also possible for a home appliance component of this family, which is relatively smaller, to use only half of the injection points present. For a home appliance component of the component family which is relatively larger, then a plurality of injection points of this original tool may be used and operated. For a component family, therefore, it is conceivable that only one injection mold with a plurality of exchangeable plates is required, instead of a plurality of completely separate injection molds.

By means of the invention, therefore, it is also possible that in addition to the technical advantages the quantities may also be reduced. Moreover, a higher component quality and a greater degree of structural freedom including a plurality of design options for additional elements is provided. Thus relative to the greater degree of freedom, individual structural features are designed more simply and more delicately and in variants of shape than is possible, for example, with thermoforming. Thus, for example, integrated protruding raised cams may be designed to be more delicate. In this context, for example, it may be provided that the cam is no longer produced as a fully raised bump-like structure, but the raised portion is produced only by a delicate peripheral edge and/or a peripheral contour line. This may then be produced with the same level of stability and with at least the same accuracy of shape.

The positions and orientations provided when the appliance is used as intended and arranged as intended and when an observer is positioned in front of the appliance and looks in the direction of the appliance, are specified by the terms “above”, “below”, “front”, “rear”, “horizontal”, “vertical”, “depth direction”, “width direction”, “vertical direction”, etc.

Further features of the invention are disclosed from the claims, the figures and the description of the figures. The features and combination of features cited above in the description and the features and combination of features cited hereinafter in the description of the figures and/or shown individually in the figures are not only able to be used in the respectively specified combination but also in other combinations without departing from the scope of the invention. Therefore, embodiments of the invention are also regarded as encompassed and disclosed which are not explicitly shown and described in the figures but are disclosed and able to be produced by separate combinations of features from the described embodiments. Moreover, embodiments and combinations of features, which therefore do not have all features of an originally formulated independent claim, may be regarded as disclosed. Moreover, embodiments and combinations of features which go beyond or deviate beyond the combinations of features set forth in the related claims, may be regarded as disclosed, in particular by the embodiments set forth above.

Exemplary embodiments of the invention are described in more detail hereinafter with reference to schematic drawings, in which:

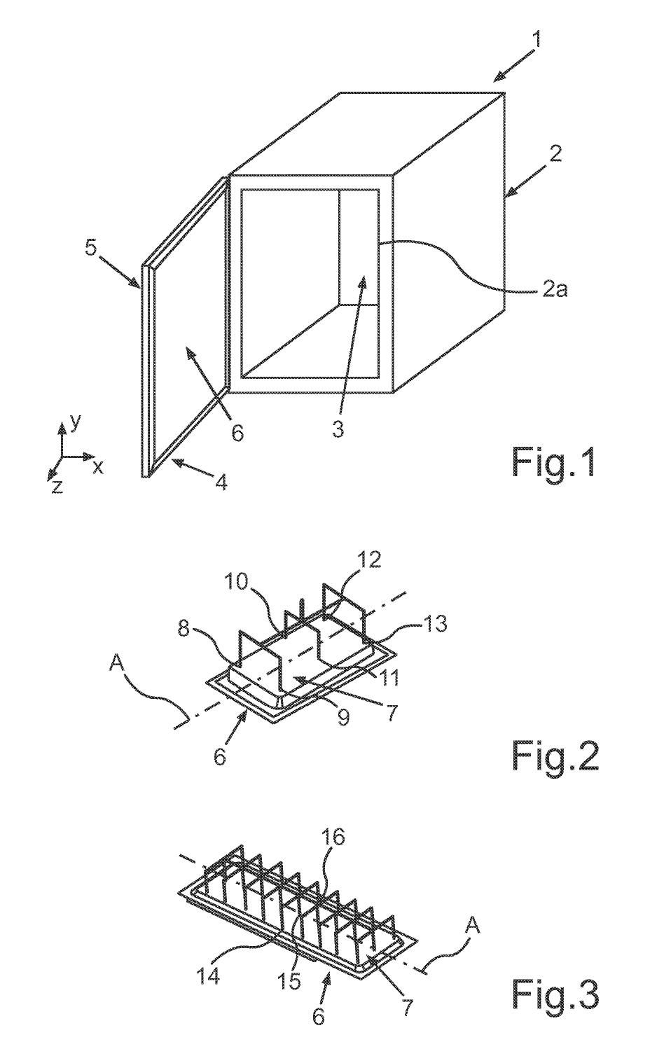

FIG. 1 shows a perspective view of an exemplary embodiment of a home appliance according to the invention with an embodiment of a home appliance component according to the invention;

FIG. 2 shows a perspective view of a first exemplary embodiment of a home appliance component with symbolically shown injection points;

FIG. 3 shows a perspective view of a further exemplary embodiment of a home appliance component having a size different from FIG. 2 and a number of injection points different from FIG. 2;

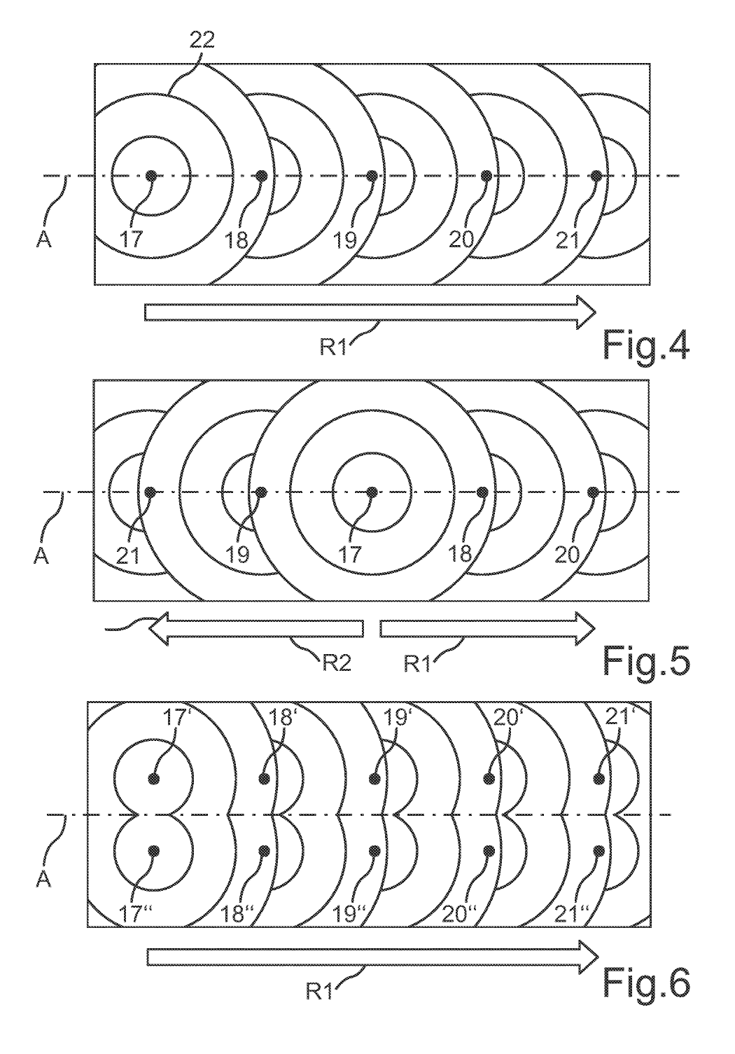

FIG. 4 shows an exemplary view of an embodiment for producing a home appliance component in which by the method according to the invention melt is introduced at different times via a plurality of injection points in series along a longitudinal axis of a home appliance component to be produced, wherein in FIG. 4 the respective flow fronts of this melt are also shown;

FIG. 5 shows a view according to FIG. 4, wherein in contrast to FIG. 4 the introduction of the melt in the injection points does not take place in one direction but in two opposing directions;

FIG. 6 shows a view according to FIG. 4 in which in contrast to FIG. 4, however, two parallel rows of injection points are configured;

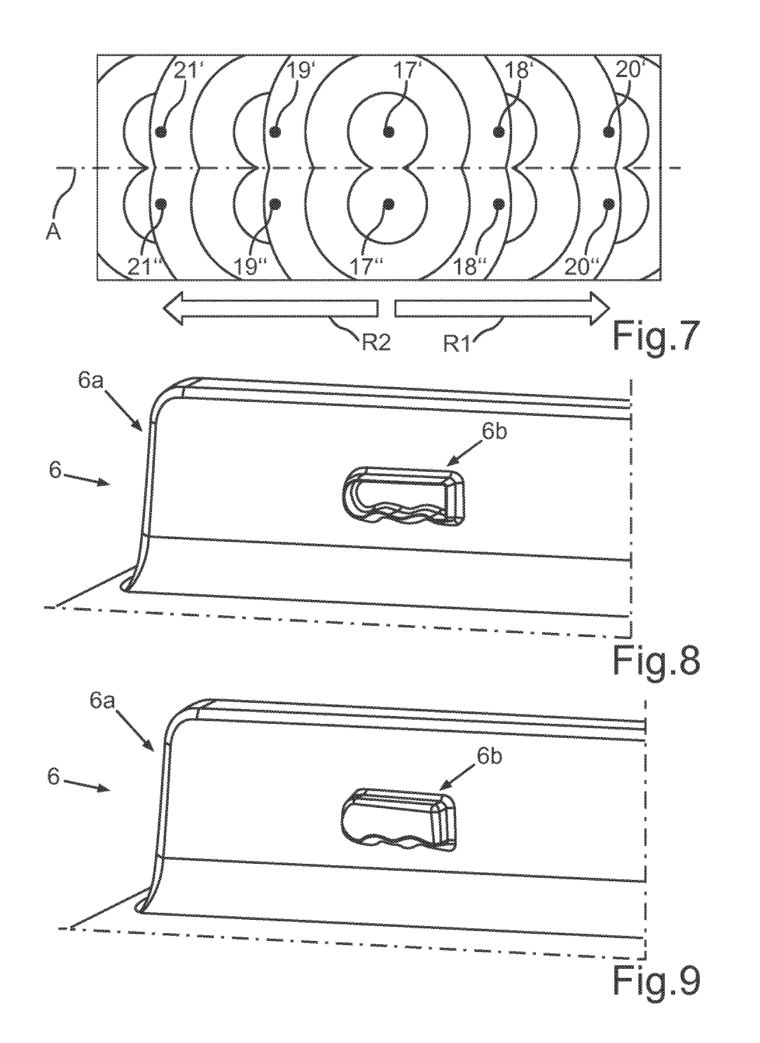

FIG. 7 shows a view according to FIG. 5 in which in contrast to FIG. 5 two parallel rows of injection points are also predetermined;

FIG. 8 shows a perspective view of a partial region of a home appliance component produced with an integrated additional element in the form of a cam; and

FIG. 9 shows a view according to FIG. 8 with a correspondingly alternatively produced cam.

In the figures, elements which are the same or functionally the same are provided with the same reference numerals.

In FIG. 1 a home appliance 1 is shown in a perspective simplified view, said home appliance being a home refrigeration appliance and, for example, a refrigerator or a freezer or a combi fridge-freezer. The home appliance 1 is configured to receive food and has a housing 2 in which a corresponding receiving space 3 is configured. The receiving space 3 is defined by walls of an internal container 2a. At the front, the receiving space 3 is closable by a door 4 which is pivotably arranged on the housing 2. The door 4 is constructed in multiple parts and has an external door 5 and an internal door which represents an internal cladding 6. The internal cladding 6 is a component on the visible side of the door 4 and thus is an external component. In the closed state of the door 4 this internal cladding 6 faces the receiving space 3. This internal cladding 6 is integrally configured from plastics and represents a trough-like home appliance component. Between the external door 5 and the internal cladding 6 a thermally insulating material, in particular an insulating foam, is at least partially incorporated, said foam not being present on the visible side but being concealed by the external door 5 and the internal cladding 6.

Moreover, further components, for example at least one door rack which is not shown, may also be arranged on the internal cladding 6.

The home appliance component in the form of the trough-like internal cladding 6 is manufactured by injection-molding, wherein during this injection-molding a combination of thin-wall injection-molding and cascade molding is carried out at least partially during the manufacturing process. The thin-wall injection-molding in this case is carried out at a wall thickness-flow path ratio of more than 1:200, in particular of between more than 1:200 and 1:300.

As may be already identified from the schematic view in FIG. 1 and in the exemplary embodiment in FIG. 2, in which this internal cladding 6 is shown horizontally, a substantially larger region of this extent of the home appliance component is a planar or substantially planar surface area which in this case is formed by a trough base 7.

As indicated in FIG. 2, during this manufacture by injection-molding and by combining the thin-wall injection-molding technique and the cascade molding, a plurality of injection points is predetermined. In the exemplary embodiment shown here, six injection points 8, 9, 10, 11, 12 and 13 are predetermined. Thus it is provided here that, viewed along a longitudinal axis A of the home appliance component to be manufactured, three injection points 8, 10, 12 in a row, which extends parallel to the axis A, are predetermined. Moreover, three further injection points 9, 11 and 13 in a row parallel thereto, which is also parallel to the longitudinal axis A, are predetermined. Moreover, it is provided that in each case two injection points are respectively arranged opposing the longitudinal axis A and symmetrically thereto in pairs and in this connection in each case are predetermined at the same longitudinal position and/or on the same portion along the longitudinal axis A. Thus a first injection point pair is predetermined by the injection points 8 and 9, a second injection point pair is predetermined by the injection points 10 and 11 and a third injection point pair is predetermined by the injection points 12 and 13.

In particular, it is provided that the injection points 10 and 11 with regard to the length of the home appliance component and thus the internal cladding 6 are centrally arranged, viewed along the longitudinal axis A. Thus they represent central injection points 10 and 11. Moreover, the injection points 8 and 9 are first eccentric injection points and the injection points 12 and 13 are second eccentric injection points. The spacing, viewed in the direction of the longitudinal axis A, is the same between the central injection point 10 and the eccentric injection points 8 and 12. The same applies to the spacing of the eccentric injection points 9 and 13 relative to the central injection point 11. As may be identified according to the view in FIG. 2, the local positions of the injection points 8 to 13 are selected such that they are still present within the surface area of the trough base 7.

The manufacture of this internal cladding 6 according to FIG. 2 is carried out, in particular, in that initially the melt is injected simultaneously via the central injection points 10 and 11. During this time phase the injection is not yet carried out via the eccentric injection points 8, 9 and 12, 13.

According to the extent of the flow front of the melt, which is introduced via the injection points 10 and 11, subsequently the injection is carried out via the eccentric injection points 8 and 9 and 12 and 13.

In particular, a time for the start of an injection in an eccentrically predetermined injection point 8, 9, 12, 13 is predetermined according to the type of melt to be injected and/or according to the type of melt injected into the at least one central injection point and/or a spacing measured along the longitudinal axis between the at least one central injection point and the eccentric injection point and/or the diameter of the at least one central injection point and/or the diameter of the eccentric injection point and/or the number of eccentric injection points at the same longitudinal position along the longitudinal axis relative to this eccentric injection point and/or the injection pressure of the melt in the at least one first central injection point and/or the injection pressure provided in the eccentric injection point and/or the quantity of the melt injected in the at least one central injection point, and/or the quantity of the melt provided to be injected in the eccentric injection point and/or a time duration of an injection of a melt via the central injection point.

Additionally or alternatively, a time for the end of an injection in an eccentrically predetermined injection point 8, 9, 12, 13 is predetermined according to the type of melt to be injected and/or according to the type of melt injected in the at least one central injection point and/or a spacing measured along the longitudinal axis between the at least one central injection point and the eccentric injection point and/or the diameter of the at least one central injection point and/or the diameter of the eccentric injection point and/or the number of eccentric injection points at the same longitudinal position along the longitudinal axis relative to this eccentric injection point and/or the injection pressure of the melt in the at least one first central injection point and/or the injection pressure provided in the eccentric injection point and/or the quantity of the melt injected in the at least one central injection point and/or the quantity of the melt provided to be injected in the eccentric injection point and/or a time duration of an injection of a melt via the central injection point.

In FIG. 3 an exemplary embodiment of a trough-shaped home appliance component which is configured as an internal cladding 6 is shown, said component being larger in contrast to the embodiment according to FIG. 2, in particular in the length along the longitudinal axis A and optionally also in width and thus in a direction perpendicular to the longitudinal axis A. The height is measured in this case according to the view in FIG. 1 in the y-direction, wherein the width with the door 4 closed is measured in the x-direction.

In the embodiment in FIG. 3, due to the size, in particular, of the planar or substantially planar surface area, the trough base 7 is correspondingly different. In this case, considerably more injection points are present than in the embodiment in FIG. 2. In the exemplary embodiment 27 injection points are provided here. Here, three central injection points 14, 15 and 16 are provided, said central injection points being arranged adjacent to one another viewed at the same axial position in the direction of the longitudinal axis A. Thus a central middle injection point 15 is located on the longitudinal axis A and is thus centrally predetermined in the width direction of the home appliance component and thus of the internal cladding 6 to be manufactured. The two further central injection points 14 and 16 are accordingly predetermined in the width direction at the same spacing from the central injection point 15 in the middle. The further 24 eccentric injection points are predetermined in their rows parallel to the longitudinal axis A and arranged relative to one another and at the same spacing from one another. Moreover, in the eccentric injection points in each case three such injection points are arranged in the same longitudinal position and thus the same axial position on the longitudinal axis A relative to one another. All eccentric injection points on the left-hand side, and thus those injection points which are predetermined to the left of the longitudinal axis A, are also predetermined in turn in a row which extends parallel to the longitudinal axis A. The same is predetermined in the case of the eccentric injection points on the right-hand side, wherein these eccentric right-hand injection points are also in the row with the central injection point 16. Correspondingly, the central injection point 16 is predetermined in a row with the eccentric injection points on the left-hand side.

Also in this case, the manufacture is carried out such that initially the injection of the melt is initiated via the central injection points 14 to 16. Also, in particular according to the influencing factors already mentioned above, an injection is initially started at a time in an eccentrically predetermined injection point and/or the injection is completed at a time in an eccentrically predetermined injection point. In particular, the temperature and/or the internal pressure in the injection mold is also taken into consideration.

In FIG. 4 an embodiment is shown in a simplified view, in which along a longitudinal axis A a plurality of injection points 17, 18, 19, 20 and 21 are predetermined in only one row. The injection of the melt in this case takes place in only one direction R1 as indicated by the arrow. The injection is initially started with the injection point 17, wherein no melt is injected in the further injection points 18 to 21. Depending on the extent of a flow front 22 of the melt in the injection mold, the injection of the melt in the injection point 18 starts in a chronologically delayed manner relative to the injection in the injection point 17. The same then continues with the further respective flow fronts, as shown in FIG. 4 but not provided with reference numerals. Thus it is also possible that the melt which has been introduced via the first injection point 17 has already cooled sufficiently, although for example a primary introduction of melt has not yet been carried out in at least the last injection point 21 in the injection row. Then it may also be provided that even before completing the primary introduction of the melt at all injection points, the secondary filling has already started at, in particular, the first injection point 17 and/or this is carried out at the same time.

The same may also be carried out additionally or alternatively at other injection points, for example at the injection point 18.

In the view in FIG. 5, in contrast to the embodiment according to FIG. 4, it is provided that after the start of the injection of the melt via a central injection point 17, at the same time respectively in two different directions R1 and R2, the injection also takes place in subsequent eccentric injection points. Thus it is provided that after the injection in the central injection point 17, or at least chronologically delayed relative to the injection, then the injection of the melt starts at the same time in the following eccentric injection points 18 and 19 and in turn is subsequently delayed chronologically, in particular according to the speed of the flow fronts, the simultaneous injection in the row then being carried out further in the outward direction at the following eccentric injection points 20 and 21.

In a further exemplary embodiment according to FIG. 6 once again an injection scenario is shown in only one direction R1. In contrast to the view according to FIG. 4, embodiments according to FIG. 2 are shown here, in which injection point pairs are provided which are predetermined on opposing sides of the longitudinal axis A, and arranged and/or predetermined symmetrically relative to the longitudinal axis A. Here it is provided that via the injection points 17′ and 17″, in particular, the injection is started simultaneously and then according to the extent of the flow fronts, subsequently and chronologically delayed, the in particular simultaneous injection takes place in the injection points 18′ and 18″. Once again chronologically delayed, the further injection takes place in the further injection points 19′ and 19″ which follow in the series, and then chronologically delayed in the injection points 20′ and 20″ and then chronologically delayed in the further injection points 21′ and 21″. With regard to the preferable fixing of times for the start and the end of the injection in the eccentric injection points, reference should be made to the aforementioned dependence on influencing factors. Here, once again in particular the temperature of the injection mold at specific points and/or an internal pressure in the injection mold may be considered. In this context, once again conclusions may be respectively drawn about the locally specific position of a flow front and the resulting requirement of a primary injection of melt in a further subsequent injection point and/or the secondary filling of melt in an already present injection point, via which the primary injection of the melt has already taken place and cooling is already sufficiently present in the region of the melt.

In FIG. 7 a further example is shown in which, in contrast to FIG. 5, here once again not only one row of injection points is provided parallel to the longitudinal axis A, but injection point pairs are present, corresponding to the embodiment in FIG. 6 in each case. The injection takes place here proceeding from the start of the injection via the central injection points 17′ and 17″, in both directions R1 and R2, at subsequent eccentric injection points, in particular simultaneously.

In FIG. 8, a detail of the internal cladding 6 is shown. Here a raised, outwardly protruding cam 6b is integrated on a projection 6a, said cam being merely configured as a border and/or edge and/or contour projection. Such an embodiment has a corresponding degree of structural freedom which results from the invention and/or an advantageous embodiment when produced by this specific combination of injection-molding sequences.

In contrast thereto, in FIG. 9 an embodiment of an internal cladding part is shown, in which such a cam 6b is only produced as a raised bump and not as a delicate structure as formed in FIG. 8. In principle, therefore, it is also possible that the cam 6b according to FIG. 9 naturally may also be produced with a corresponding shape by means of the invention or an advantageous embodiment thereof. By means of the variants, as are shown in FIG. 8 and FIG. 9 in examples of shapes, a further advantage of the invention is also further reinforced.

### LIST OF REFERENCE NUMERALS

1 Home appliance
2 Housing
2a Internal container
3 Receiving space
4 Door
5 External door
6 Internal cladding
6a Projection
6b Cam
7 Trough base
8 Injection point
9 Injection point
10 Injection point
11 Injection point
12 Injection point
13 Injection point
14 Central injection point
15 Central injection point
16 Central injection point
17, 17′, 17″ Injection point
18, 18′, 18″ Injection point
19, 19′, 19″ Injection point
20, 20′, 20″ Injection point
21, 21′, 21″ Injection point
22 Flow front
A Longitudinal axis
R1 Direction
R2 Direction

1-17. (canceled)

18. A method for manufacturing a home appliance component for a home appliance, the method comprising the following steps:
producing the home appliance component from plastic;
manufacturing the home appliance component by an injection-molding process; and
using a combination of thin-wall injection-molding and cascade molding during at least some phases of the injection-molding process.

19. The method according to claim 18, which further comprises carrying out the thin-wall injection-molding at a wall thickness-flow path ratio of more than 1:200.

20. The method according to claim 19, which further comprises carrying out the thin-wall injection-molding at a wall thickness-flow path ratio of between more than 1:200 and 1:300.

21. The method according to claim 18, which further comprises carrying out the cascade molding by:
centrally predetermining, in a direction of a longitudinal axis of the home appliance component to be manufactured, at least one injection point of a plurality of injection points through which an injection of a melt of a plastics material into an injection mold is initiated at least partially before an injection of the melt in at least one further injection point being predetermined eccentrically in the direction of the longitudinal axis.

22. The method according to claim 21, which further comprises:
predetermining a time for a start of an injection in an eccentrically predetermined injection point according to at least one of:
a type of melt to be injected, or
a type of melt injected in the at least one central injection point, or
a spacing measured along the longitudinal axis between the at least one central injection point and the eccentric injection point, or
a diameter of the at least one central injection point, or
a diameter of the eccentric injection point, or
a number of eccentric injection points at an identical longitudinal position along the longitudinal axis relative to the eccentric injection point, or
an injection pressure of the melt in at least one first central injection point, or
an injection pressure provided in the eccentric injection point, or
a quantity of the melt injected in the at least one central injection point, or
a quantity of the melt provided to be injected in the eccentric injection point, or
a time period of an injection of a melt through the central injection point, or
predetermining a time for an end of an injection in an eccentrically predetermined injection point according to:
the type of melt to be injected, or
the type of melt injected in the at least one central injection point, or
the spacing measured along the longitudinal axis between the at least one central injection point and the eccentric injection point, or
the diameter of the at least one central injection point, or
the diameter of the eccentric injection point, or
the number of eccentric injection points at the same longitudinal position along the longitudinal axis relative to the eccentric injection point, or
the injection pressure of the melt in the at least one first central injection point, or
the injection pressure provided in the eccentric injection point, or
the quantity of the melt injected into the at least one central injection point, or
the quantity of the melt provided to be injected in the eccentric injection point, or
the time period of an injection of a melt through the central injection point.

23. The method according to claim 21, which further comprises:
predetermining at least one first eccentric injection point in at least the one central injection point in a first direction along the longitudinal axis; and
starting from the at least one central injection point, predetermining at least one second eccentric injection point in a second direction opposing the first direction along the longitudinal axis; and
with the injection of the melt in the at least one central injection point, partially or entirely simultaneously carrying out the injection of a melt in the at least one first and the at least one second eccentric injection points.

24. The method according to claim 18, which further comprises carrying out the cascade molding by predetermining at least two injection points on an identical longitudinal position and on opposing sides of a longitudinal axis of the home appliance component to be manufactured from a plurality of injection points through which a melt of plastics material is injected simultaneously into an injection mold.

25. The method according to claim 18, which further comprises using the combination of the thin-wall injection-molding and the cascade molding to manufacture the home appliance component with a wall thickness of less than 1.5 mm.

26. The method according to claim 18, which further comprises using the combination of the thin-wall injection-molding and the cascade molding to manufacture the home appliance component with a wall thickness of between 0.6 mm and 1 mm.

27. The method according to claim 18, which further comprises predetermining at least four injection points for the cascade molding.

28. The method according to claim 18, which further comprises manufacturing the home appliance component with a trough-shape.

29. The method according to claim 28, which further comprises manufacturing the trough-shaped home appliance component with a trough base having a quadrangular surface area with at least one of a first side length or width of at least 30 cm or a second side length or height of at least 25 cm.

30. The method according to claim 28, which further comprises predetermining at least one of a number or position of injection points for the cascade molding according to a size of the trough-shaped home appliance component or a size of a surface area of a trough base of the home appliance component.

31. The method according to claim 30, which further comprises predetermining at least one of a number of injection points along a longitudinal axis of the home appliance component to be manufactured or a position of the injection points along the longitudinal axis of the home appliance component to be manufactured according to the size of the trough-shaped home appliance component or the size of the surface area of the trough base of the home appliance component.

32. The method according to claim 30, which further comprises predetermining the number of injection points in pairs and on opposing sides of a longitudinal axis of the trough-shaped home appliance component, and predetermining the number of injection point pairs according to the size of the trough-shaped home appliance component or the size of the surface area of the trough base of the home appliance component.

33. The method according to claim 18, which further comprises limiting a locking force for locking an injection mold when injection-molding the home appliance component to a value of less than or equal to a weight of 1700 tons.

34. The method according to claim 18, which further comprises manufacturing an internal cladding of a door for a home refrigeration appliance as the home appliance component.

35. In a home appliance, the improvement comprising:
an injection-molded plastic home appliance component having characteristics of having been formed by a combination of thin-wall injection-molding and cascade molding during at least some phases of injection-molding.
